(19) United States
(12) Patent Application Publication
(10) Pub. No.: US 2003/0224655 A1
(43) Pub. Date: Dec. 4, 2003

(54) Multi-function clip

(75) Inventors: Sheng-Chung Chen, Pingtung (TW); Tai-Tung Lien, Miaoli (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Accton Technology Corporation, Hsinchu (TW)

(21) Appl. No.: 10/162,014

(22) Filed: Jun. 3, 2002

(51) Int. Cl. H01R 13/60

(52) U.S. Cl. 439/574

(57) ABSTRACT

A multi-function clip is disclosed. The present application is suitable for use in connecting with the pocket-sized wireless universal serial bus (USB) adapter, but is not limited thereto, wherein the present application comprises a main body and a clipping member. After the multi-function clip is connected to the pocket-sized wireless USB adapter, the pocket-sized wireless USB adapter comprises the multi-functions of desktop type, wall-mount type, attaching type, and clipping type.

### FIELD OF THE INVENTION

The present invention relates to a multi-function clip, and more particularly, to a multi-function clip suitable for use with the pocket-sized wireless universal serial bus (USB) adapter.

### BACKGROUND OF THE INVENTION

The newly-purchased personal computer supports an interface technology called USB. The USB interface technology provides the connection between a central processing unit (CPU) and newly-added peripheral elements, thereby automatically configuring the newly-added peripheral elements to the computer. Moreover, the USB interface supports a lot of equipments by the way of serially connection, i.e. first connecting the first equipment to the computer; then connecting the second equipment to the first equipment; and thereafter connecting the third equipment the second equipment; and so on.

Generally, the peripheral hardware uses a wire (or cable) to connect to the computer through the USB interface, but also can use a wireless way. For example, some mobile phones can communicate with the computer by the wireless USB interface. While the communication is handled by the wireless USB interface, a wireless adapter is used to receive and send wireless signals, wherein the computer is connected to the wireless adapter through the USB interface with a wire, and then the wireless adapter communicates with the peripheral hardware such as the mobile phone wirelessly.

There are many varieties of the aforementioned wireless adapter, and one of them is the pocket-sized wireless USB adapter. The pocket-sized wireless USB adapters can be classified into a portable type and a desktop type from the viewpoint of design, and into a desktop type and a wall-mount type form the viewpoint of use, wherein the type actually applied is determined by the user's environment.

Since the main body of the aforementioned portable pocket-sized wireless USB adapter is light in weight and small in size, it is very easily to be tipped over and cannot stay steadily while being connected to a USB cable. Moreover, since the portable pocket-sized wireless USB adapter is featured in wireless communication, it has to be placed on a higher position or on a space without barriers so as to obtain the best communication effect.

### SUMMARY OF THE INVENTION

Just as described above, the conventional pocket-sized wireless USB adapter still has room for improvement with regard to the holding mechanism. Hence, an objective of the present invention is to provide a multi-function clip connected to the pocket-sized wireless USB adapter, whereby the pocket-sized wireless USB adapter can be placed on the desk, placed or hung on a higher position, or further clipped on any proper places.

Another objective of the present invention is to provide a multi-function clip, wherein the material forming the multi-function clip is an elastic material such as plastics, so that the complicated movable mechanism is not required, thereby substantially saving the cost of parts.

According to the aforementioned objectives of the present invention, the present invention provides a multi-function clip suitable for use with a wireless USB adapter, wherein the multi-function clip comprises: a main body; and an clipping member having at least one positioning hole and a cross-section of such as L-shape, wherein one side of the clipping member is connected to the main body and the other side of the clipping member is able to extend outwards because of the elasticity of the clipping member. Moreover, the present invention also comprises at least one attaching element placed in the at least one positioning hole and installed on the clipping member. Furthermore, after the at least one attaching element is placed in the at least one positioning hole, there is a gap existing in the at least one positioning hole, so that the wireless USB adapter can be hung on at least one nail of a wall via the gap.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a 3D diagram showing the multi-function clip according to an embodiment of this invention;

FIG. 2 is a diagram showing the front view of the multi-function clip according to an embodiment of this invention;

FIG. 3 is a diagram showing the top view of the multi-function clip according to an embodiment of this invention;

FIG. 4 is a diagram showing the right side view of the multi-function clip according to an embodiment of this invention and a conventional vertical partition; and

FIG. 5 is a diagram showing how the multi-function clip according to an embodiment of this invention and the pocket-sized wireless USB adapter are connected.

### DETAILED DESCRIPTION OF THE PREFERRED EMBODIMENT

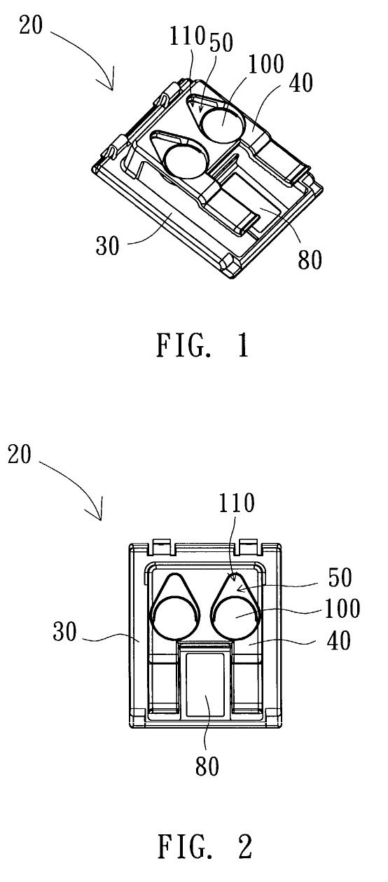

The present invention is suitable for use in connecting to the pocket-sized wireless USB adapter. The pocket-sized wireless USB adapter of the present invention has multi-functions including a desktop type, a wall-mount type, an attaching type, and a clipping type after connecting to the pocket-sized wireless USB adapter. Please refer to the 3D view, front view, top view, and right side view respectively shown from FIG. 1 to FIG. 4. The multi-function clip 20 comprises a main body 30 and an clipping member 40. The material forming the main body 30 and the clipping member 40 is such as plastics, but the present invention is not limited thereto. If the main body 30 and the clipping member 40 both are made of plastics, the main body 30 and the clipping member 40 can be formed in one single piece of material without the complicated movable mechanism needed, thereby saving the cost of parts substantially. However, the clipping member 40 has to be made of an elastic material in order to perform the function of clipping type (referring to the following description), although the material of the clipping member 40 is not necessary to be plastics. Moreover, the shape of the main body 30 can be a solid plate such as a rectangular solid plate or a solid plate of any other shape. However, the shape of the main body 30 can also be a hollow frame, which means that the hollow frame is formed from the aforementioned solid plate with an opening penetrating from one surface having the maximum surface area to the other surface. The following description is the connecting relationships among the elements of this invention.

Please refer to FIG. 4, which is the diagram showing the right side view of the multi-function clip according to an embodiment of this invention and a conventional vertical partition. The clipping member 40 has a cross-section of such as L-shape composed of a first side 45 and a second side 60, wherein the first side 45 is opposite to the second side 60. The first side 45 of the clipping member 40 is connected to the main body 30, and the second side 60 is able to perform a horizontal displacement movement of extending away from or approaching towards the main body 30 in the direction as shown by the arrow 70. The horizontal displacement movement of the second side 60 is achieved due to the elasticity of the clipping member 40. When the multi-function clip 20 is closed to the external vertical partition 11 in the direction as shown by the arrow 72 with a space 71 formed between the second side 60 and the main body 30, the top end of the vertical partition 11 is plugged into the space 71. Even though the width of the top end of the vertical partition 11 is larger than the width of the space 71 formed between the second side 60 and the main body 30, the second side 60 still can extend outwards in the direction of the arrow 70 due to the elasticity of the clipping member 40, whereby the multi-function clip 20 can clip the vertical partition 11 tightly. The vertical partition 11 indicated herein stands for any object that can be clipped by the multi-function clip 20 of the present invention. Moreover, the vertical partition 11 is not necessary to be exactly vertical to the x-z horizontal plane. For example, the plane 130 where the vertical partition 11 is located may have some degrees of angle with respect to the y direction, as long as the multi-function clip 20 does not slip off while clamping the vertical partition 11. Besides, there is a plurality of anti-slip ribs 75 located on a portion of a surface of the clipping member 40, so that the multi-function clip 20 is able to clip the vertical partition 11 more firmly. When the multi-function clip 20 is clipping the vertical partition 11, the anti-slip ribs 75 are in contact with the vertical partition 11. Furthermore, the present invention has a block 80 to limit the depth with which the top end of the vertical partition 11 is inserted. The block 80 is installed on the main body 30, and the shape of the block 80 is not limited to a specific shape provided that the block 80 is able to perform the limiting function. With regard to the position of the block 80, basically, no particular limitation is used. However, when the block 80 is located more closely to the second side 60, the space 71 is smaller, and the effect that the multi-function clip 20 clips the vertical partition 11 is less accordingly. On the contrary, when the block 80 is located farther from the second side 60, the space 71 is bigger, and to the extreme, the function of the block 80 can be performed alternatively by a portion of the clipping member 40 near the first side 45. Therefore, the depth with which the top end of the vertical partition 11 in inserted can be unrestricted, which means that the block 80 is not a necessary element. Accordingly, the multi-function clip 20 without the block 80 is also within the claimed scope of the present invention.

Then, the following description is stated for the attaching type function of the multi-function clip 20. There is at least one positioning hole 50 on the surface 90 of the clipping member 40 to perform the attaching type function (FIG. 1 and FIG. 2). Number of the positioning holes 50 in FIG. 1 and FIG. 2 is two, but the present invention is not limited thereto provided that the number of the at least one positioning hole 50 can achieve the attaching type function of the present invention. The at least one positioning hole 50 may be a hole completely penetrating through the clipping member 40, or an area deep into a portion of the thickness of the clipping member 40 so as to form a depression structure. Moreover, the multi-function clip 20 of the present invention also can have at least one attaching element 100 placed in the at least one positioning hole 50, and installed on the clipping member 40. The at least one attaching element 100 can be for example a magnet or a Velcro, but the present invention is not limited thereto, as long as the pocket-sized wireless USB adapter can be attached to the vertical plate (such as the wall) more firmly by the at least one attaching element 100 after the pocket-sized wireless USB adapter is connected to the multi-function clip 20 of the present invention. It is well known that, if at least one attaching element 100 is a magnet, then the above vertical plate has to be made of the magnet-attachable material.

Regarding the wall-mount type function, it is achieved by the gap 110 in the positioning hole 50. After the attaching element 100 is placed in the positioning hole 50, there is still some extra space in the positioning hole 50 so as to form the gap 110. After being connected to the multi-function clip 20, the pocket-sized wireless USB adapter can be hung by fitting the gap 110 with a protrusion (such as a nail) located on a wall, thereby overcoming the disadvantage of the conventional clip not having the wall-mount function.

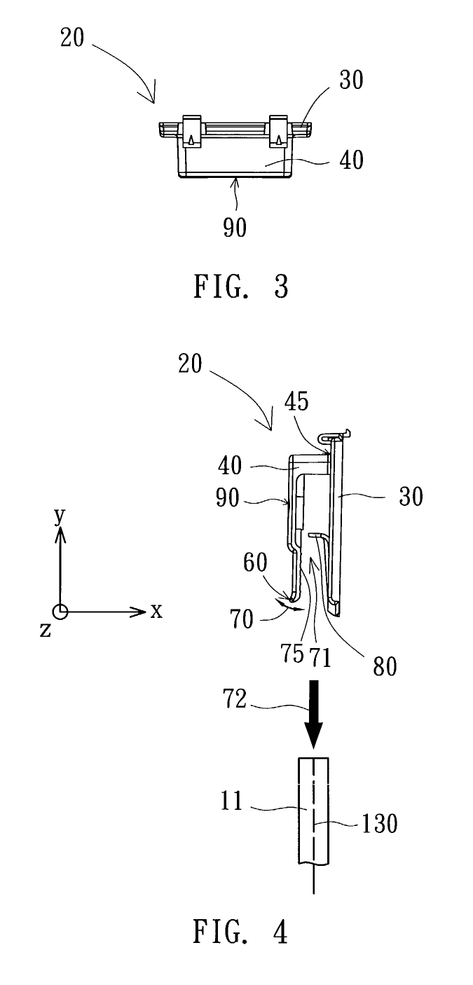

Moreover, such as shown in FIG. 3 and FIG. 4, the pocket-sized wireless USB adapter can use the surface 90 of the clipping member 40 facing downwards to be positioned steadily on a horizontal surface of an object (such as a computer desk), so as to achieve the desktop type function of the present invention. Therefore, the multifunction clip 20 can overcome the disadvantage of the portable pocket-sized wireless USB adapter that is easily to be tipped over and cannot be held steadily when being placed on an object (such as the desktop).

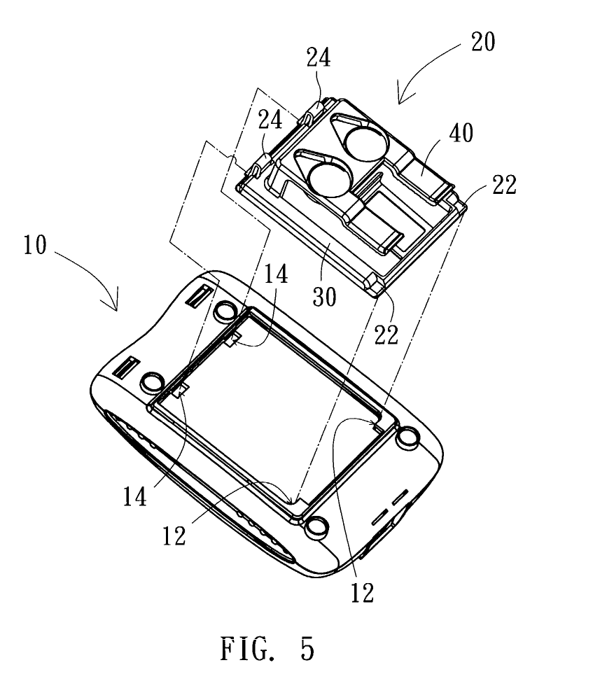

Referring to FIG. 5, FIG. 5 showing how the multi-function clip according to an embodiment of this invention and the pocket-sized wireless USB adapter are connected. In addition to the aforementioned main elements of the present invention, the present invention further comprises the slices 22 and the hooks 24 used for joining the present invention and the pocket-sized wireless USB adapter 10 together. The two slices 22 are placed on one side of the main body 30 and the two hooks 24 are placed on the other side of the main body 30. The two slices 22 are plugged into the two sockets 12 respectively, and the two hooks 24 are plugged into the two cavities 14 respectively to join the multi-function clip 20 of the present invention and the pocket-sized wireless USB adapter 10 together. The slices 22, the hooks 24, the sockets 12, and the cavities 14 can be made in any arbitrary shape provided that the multi-function clip 20 and the pocket-sized wireless USB adapter 10 can be joined together tightly. Thus, the multifunction clip 20 and the pocket-sized wireless USB adapter 10 are joined together to form one integrated body, so that the pocket-sized wireless USB adapter 10 can own the multi-functions of desktop type, wall-mount type, attaching type, and clipping type in accordance with various designs of the multi-function clip 20.

To sum up, one advantage of the present invention is to provide a multi-function clip connected to the pocket-sized wireless USB adapter, whereby the pocket-sized wireless USB adapter can be placed on the desk, placed or hung in a high position, or clipped at any proper places.

Another advantage of the present invention is to provide a multi-function clip wherein the material of the multi-function clip is an elastic material such as plastics, so that the complicated movable mechanism is not required, thereby substantially saving the cost of parts.

As is understood by a person skilled in the art, the foregoing preferred embodiments of the present invention are illustrations of the present invention rather than limitations of the present invention. It is intended to cover various modifications and similar arrangements comprised within the spirit and scope of the appended claims, the scope of which should be accorded the broadest interpretation so as to encompass all such modifications and similar structure.

What is claimed is:

1. A multi-function clip, suitable for use with a wireless universal serial bus (USB) adapter, wherein the multi-function clip comprises:
a main body; and
a clipping member having at least one positioning hole, wherein a first end of the clipping member is connected to the main body and a second end of the clipping member is unrestrained.

2. The multi-function clip according to claim 1, wherein the main body is connected to the wireless universal serial bus (USB) adapter.

3. The multi-function clip according to claim 1, wherein a plurality of anti-slip ribs are installed on the clipping member.

4. The multi-function clip according to claim 1, wherein the clipping member has a surface keeping the wireless USB adapter steady while being placed on a surface of an object by the surface of the clipping member, wherein the at least one positioning hole is located on the surface of the clipping member.

5. The multi-function clip according to claim 1, comprising at least one attaching element placed in the at least one positioning hole, wherein the at least one attaching element is installed on the clipping member.

6. The multi-function clip according to claim 5, wherein the at least one attaching element is made of the material selected from a group consisting of magnet and Velcro.

7. The multi-function clip according to claim 5, wherein there is a gap in the at least one positioning hole, so that the wireless USB adapter can be hung on a protrusion via the gap.

8. A multi-function clip, comprising:
a main body;
a clipping member having at least one positioning hole and a L-shape cross-section that is composed of a first side and a second side, wherein a first end of the first side of the clipping member is connected to the main body and a second end of the first side is connected to the second side; and
at least one attaching element installed in the at least one positioning hole of the clipping member.

9. The multi-function clip according to claim 8, wherein the second side of the clipping member is able to extend outwards due to the elasticity of the clipping member, whereby the multi-function clip can clip an external object tightly.

10. The multi-function clip according to claim 8, wherein one portion of a surface of the clipping member has a plurality of anti-slip ribs.

11. The multi-function clip according to claim 8, wherein the second side of the clipping member has a surface keeping the multi-function clip steady while being placed on a surface of an object by the surface of the clipping member, wherein the at least one positioning hole is located ed on the surface of the clipping member.

12. The multi-function clip according to claim 8, wherein the at least one attaching element is made of the material selected from a group consisting of magnet and Velcro.

13. The multi-function clip according to claim 8, wherein there is a gap in the at least one positioning hole, so that the multi-function clip can be hung on a protrusion via the gap.
